(19) United States
(12) Patent Application Publication
(10) Pub. No.: US 2025/0006216 A1
(43) Pub. Date: Jan. 2, 2025

(54) SYSTEMS AND METHODS FOR LOW-POWER FULLY DIGITAL RATE CONVERSION USING PRE- OR POST- JITTER NOISE REDUCTION

(71) Applicant: Qorvo US, Inc., Greensboro, NC (US)

(72) Inventor: Andrew Fort, Kortrijk (BE)

(21) Appl. No.: 18/738,803

(22) Filed: Jun. 10, 2024

Related U.S. Application Data
(60) Provisional application No. 63/510,606, filed on Jun. 27, 2023.

(51) Int. Cl. G10L 21/043

(52) U.S. Cl. CPC G10L 21/043

(57) ABSTRACT

A method for digital audio conversion is provided. The method includes receiving, at a first sampling rate, a digital audio data stream at a device. The method includes generating, by a clock connected to the device, a second sampling rate, wherein the second sampling rate approximates the first sampling rate by selecting cycles of the clock closest to the cycles of the first sampling rate. The method also includes sampling the digital audio data stream at the second sampling rate to generate a second audio data stream. The method further includes transmitting the second audio data stream to a codec.

### CROSS-REFERENCE TO RELATED APPLICATION

This application claims priority to U.S. Provisional Application No. 63/510,606 filed on Jun. 27, 2023, the benefit of which is claimed and the disclosure of which is incorporated herein in its entirety.

### FIELD OF THE DISCLOSURE

The present disclosure relates to signal processing, in particular to fully-digital audio conversion facilitating the wireless transfer of high-fidelity audio information.

### BACKGROUND

In wireless audio applications, data is captured on one device, transferred wirelessly to remote device(s), then played back on the remote device(s). This process is complicated by the fact that each device has an independent clock that is running at slightly different rates. Conventionally, to resolve this problem, the devices have two options: they can either (1) change their audio clock rate to match the clock rates of the other devices, or they can (2) digitally resample the audio signal so it matches the local clock rate. The first approach typically involves a separate analog phase-locked loop used specifically for audio applications which can be adjusted for any clock rate. The second approach can require complex high-power digital filter designs to maintain sufficient SNR for high-fidelity audio applications, e.g., transferring music data to high-quality stereo speakers.

However, challenges still exist. The first approach leads to additional analog circuitry and higher costs, while the second approach can consume significant power and/or computing resources when implemented on DSP processors. Thus, conventional high-performance resampling techniques consume significant power and/or require expensive analogue components.

Consequently, there is a need for better systems to handle the frequency mismatch between the clocks of different devices.

### SUMMARY

In an exemplary aspect, the present disclosure is directed to a method for digital audio conversion. The method also includes receiving, at a first sampling rate, a digital audio data stream at a device. The method also includes generating, by a clock connected to the device, a second sampling rate, where the second sampling rate approximates the first sampling rate by selecting cycles of the clock closest to the cycles of the first sampling rate. The method also includes sampling the digital audio data stream at the second sampling rate to generate a second audio data stream. The method also includes transmitting the second audio data stream to a codec.

In some aspects, implementations may include one or more of the following features. The method where the clock has a frequency between 16 MHz and 200 MHZ. The digital audio data stream is received over Bluetooth. The digital audio data stream is received over Wi-Fi. The first sampling rate includes a sampling frequency error. The method may include estimating, at the device, the sampling frequency error. In some embodiments, generating a second sampling rate may further include correcting for a jitter error. The jitter error is corrected using interpolation.

In an exemplary aspect, the present disclosure is directed to a method for digital audio conversion. The method also includes receiving analog audio signal at a device; generating, by a clock connected to the device, a first sampling rate, where the first sampling rate approximates a second sampling rate by selecting cycles of the clock closest to the cycles of the first sampling rate. The method also includes transforming, by an analog-to-digital converter at the first sampling rate, the analog audio signal into a digital audio signal. The method also includes computing a jitter error based on the clock. The method also includes correcting the digital audio signal based on the computed jitter error.

In some aspects, implementations may include one or more of the following features. The method where the clock has a frequency between 16 MHz and 200 MHz. The method may include transmitting the corrected digital audio signal over Bluetooth. The method may include transmitting the corrected digital audio signal over Wi-Fi. The first sampling rate includes a sampling frequency error. The digital audio signal is corrected using interpolation.

In an exemplary aspect, the present disclosure is directed to a device. The device also includes a transmitter; a receiver; a clock; a non-transitory memory storing instructions; and one or more hardware processors configured to execute the instructions to cause the device to perform operations that may include: receiving, at a first sampling rate, a digital audio data stream at a device; generating, by a clock connected to the device, a second sampling rate, where the second sampling rate approximates the first sampling rate by selecting cycles of the clock closest to the cycles of the first sampling rate. The device also includes sampling the audio data stream at the second sampling rate to generate a second audio data stream; and transmitting the second audio data stream to a codec.

In some aspects, implementations may include one or more of the following features. The device where the clock has a frequency between 16 MHz and 200 MHz. The digital audio data stream is received over Bluetooth. The digital audio data stream is received over Wi-Fi. One or more hardware processors further configured to execute instructions to cause the device to perform operations that may include: correcting jitter error in the second audio data stream.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 illustrates exemplary wireless communication of audio information, according to some aspects of the present disclosure.

FIG. 2 illustrates an audio device, according to aspects of the present disclosure

FIG. 3 is block diagram depicting clock rate-matching for audio conversion, according to some aspects of the present disclosure.

FIG. 4 is a graph of an analog signal and digital sampling of the signal, according to some aspects of the present disclosure.

FIG. 5 is a block diagram depicting clock rate-matching for audio conversion, according to some aspects of the present disclosure.

FIG. 6 illustrates an exemplary method for digital audio conversion, according to some aspects of the present disclosure.

FIG. 7 illustrates an exemplary method for digital audio conversion, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each diagram or flowchart and combinations of the diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although specific clock rates and frequencies may be used to describe embodiments herein, other clock rates and frequencies may be used.

Next-generation Internet-of-Things (IoT) systems require more advanced audio signal processing to wirelessly transfer high-fidelity voice and music information. As this data is being transferred between devices with independent clocks, devices will need to resample the data during playback and recording to maintain synchronization. Further, although a particular function or feature may be described in terms of a hardware or software implementation in connection with embodiments, the embodiments may utilize the other implementation where similar technical features are achievable.

As previously described, the wireless transfer of audio data between devices requires accounting for the differing clock rates of the devices. Audio data from a remote device will be sampled nominally at a typical rate of Fs=16/32/44.1 kHz. However, due to clock inaccuracies in each device, the actual rate will be slightly different. Typical BLE wireless audio systems have a sampling frequency error of up to 1000 ppm. The actual sampling frequency error can be estimated in the local device allowing it to generate a clock at the remote Fs±1000 ppm frequency so that each received audio sample can be provided to the CODEC device and speaker at the correct rate.

It is beneficial to have a fully digital approach by generating a clock by cycle-counting from an available high-speed clock on a device. This has the advantage of avoiding costly analogue components and design-time. A convenient sampling rate may be 192 MHz because similar sampling rates are used by DCDC converters, ARM processors, and USB systems which are commonly supported in wireless IoT devices. Thus, a high-speed 192 MHz clock is typically available already on many IoT systems so that no new hardware is required. Generating an arbitrary clock rate from a fixed 192 Mhz clock involves selecting the closest clock edge to the desired clock edge.

Embodiments of the present disclosure provide a systems and methods for fully digital audio conversion that achieves high-fidelity audio quality at a lower power consumption and cost than conventional techniques.

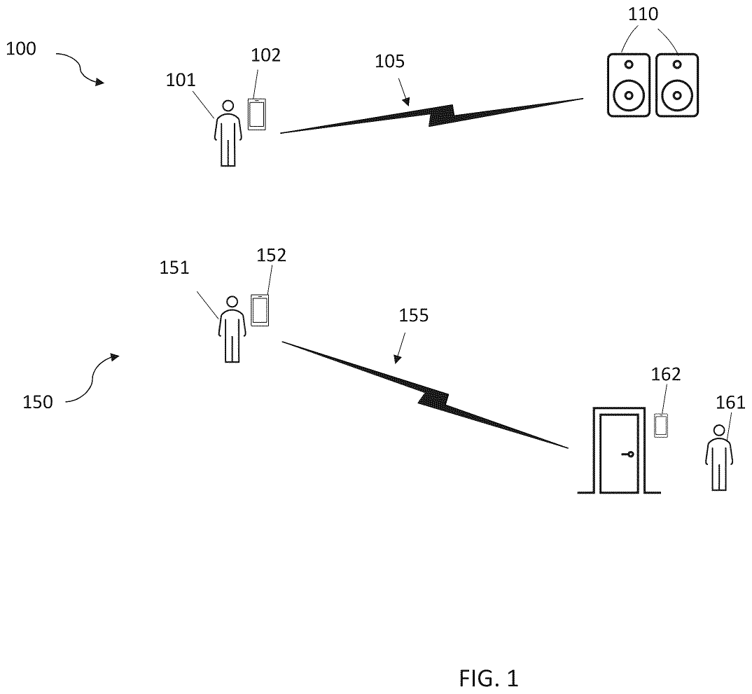

FIG. 1 illustrates two scenarios where wireless communication of audio information occurs. Generally, these scenarios depict users 101, 151 wirelessly transferring audio data from one device to another.

In the first scenario 100, a user 101 interacts with their device 102 to play music or other audio from speakers 110. Both device 102 and speakers 110 may be Bluetooth-enabled, facilitating a wireless connection 105 between the device 102 and speakers 110 (or possibly between the device 102 and another device serving as an intermediary between the device 102 and the speakers 110). In some instances, the speakers 110 may be contained in wireless earbuds.

In the second scenario 150, a user 151 may speak into a microphone on a device 152. The device 152 transmits the speech as an audio signal to device 162. Device 162 may play the audio signal through speakers, allowing the user 161 to hear the audio from user 151. As depicted, the second scenario may take place because user 161 has pressed a doorbell that ultimately is brought to the attention of user 151. In both scenarios, the fully-digital conversion of audio data may be employed.

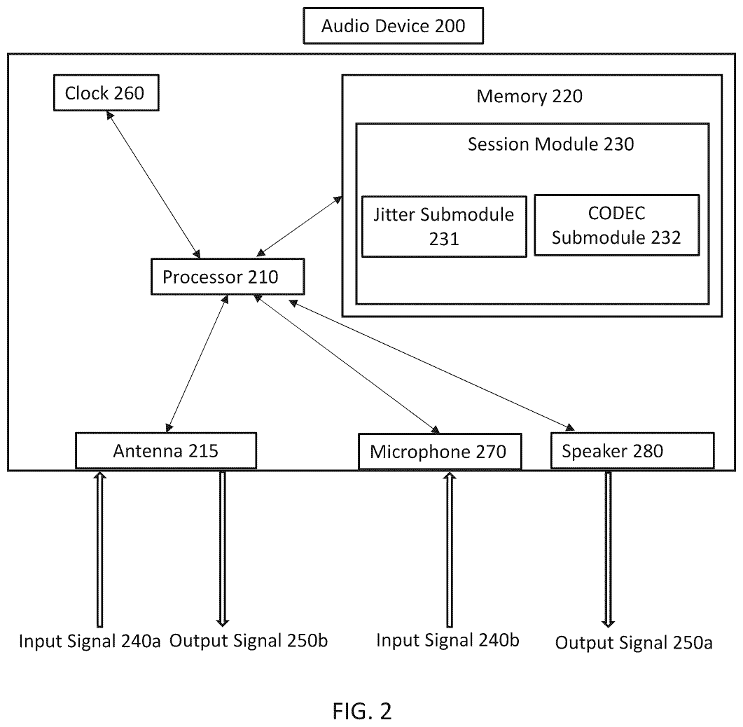

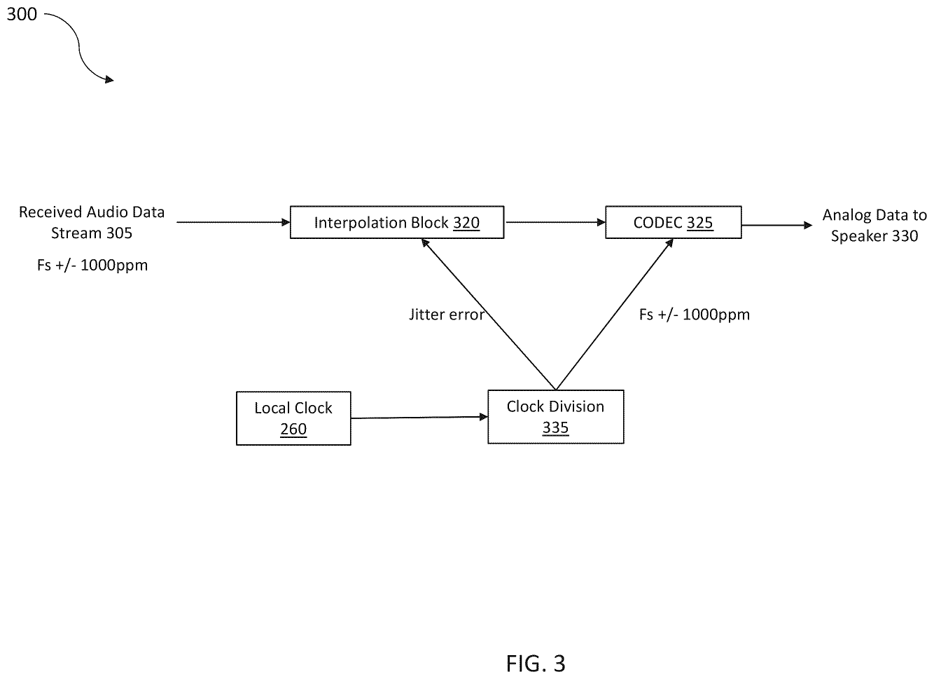

FIG. 2 is a simplified diagram of an audio device 200. The audio device 200 may be present in the environment and use cases depicted in, and described with respect to, FIG. 1, according to one embodiment described herein. Furthermore, the audio device 200 and its constituent components may carry out of the functions and features as described with respect to FIGS. 3-7. As shown in FIG. 2, audio device 200 includes a processor 210 coupled to memory 220. Operation of audio device 200 is controlled by processor 210. And although audio device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in audio device 200. Audio device 200 may be implemented as a stand-alone subsystem, as a board added to a computing device, and/or partially or wholly as a virtual machine.

Memory 220 may be used to store software executed by audio device 200 and/or one or more data structures used during operation of audio device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for Session Module 230 that may be used to implement and/or emulate the systems and models, and/or to implement any of the methods described further herein. Session Module 230 may receive input signal 240a via the antenna 215 and generate an output signal 250a through a speaker 280 which may be the audio originally received as audio data encoded in the input signal 240a. Session Module 230 may receive input signal 240b via a microphone 270 and generate output signal 250b through the antenna 215 which may be a digital form of the audio input signal 240b originally recorded by the microphone 270. Examples of the input signal may include the audio data transmitted from a remote device. The input signal may be a digital audio signal or sample or pressure waves giving rise to sound that are recorded at a microphone 270. Examples of the output signal may include transmission of digital audio data to a remote device of the pressure waves generated by a speaker 280.

The antenna 215 may comprise a transceiver, separately, a transmitter and a receiver, or any other means of transmitting audio data. For example, the audio device 200 may receive the input signal 240 (such as digital audio data) from a remote device at the antenna 215.

In some embodiments, the Session Module 230 is configured to control the content and timing of output signals 250a,b. The Session Module 230 may further include a Jitter Submodule 231 (e.g., instructions to calculate and correct the jitter error as described herein) and/or CODEC Submodule 232. In some examples, a hardware audio CODEC may be used instead of a software CODEC.

Some examples of audio devices, such as audio device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

In some embodiments, clock 260 may generate a clock signal from an electronic oscillator circuit, e.g., a crystal oscillator. Typically, the clock 260 will have a frequency between 16 MHz-200 MHz, though other frequencies may be available, depending on the clock's function within the device including, but not limited to, a clock source for DCDC conversion, USB interfaces, or ARM processors. In general, any clock may be used that has a frequency exceeding the sampling rate of the audio signal.

FIG. 3 is a block diagram depicting clock rate-matching 300 for audio conversion, according to some aspects of the present disclosure. An audio data stream 305 on a device with a local clock 310, is passed to an interpretation block 320, which corrects for the jitter error created by clock division 335, and then passed to a CODEC 325. In some examples, CODEC 325 outputs analog data 330 which may be sent to a speaker.

The received audio data stream 305 may be received using a wireless connection over, for example, Bluetooth, Wi-Fi, or other wireless protocols. The received audio data stream is a digital audio signal originally transmitted at a given sampling rate Fs. In some aspects, the sampling rate has a sampling frequency error of approximately 1000 ppm in a Bluetooth wireless audio system. Thus received audio data stream appears to have a sampling rate of Fs+/−1000 ppm.

A local clock 260 may be formed out of an electronic oscillator, e.g., a crystal oscillator. In some aspects, the frequency of the local clock should exceed the sampling rate Fs of the received audio data stream 305. The local clock 260 and the clock signal it generates may serve other functions in the device 200 including, but not limited to, a clock source for DCDC conversion, USB interfaces, or ARM processors. The clock signal from local clock 260 may be divided by a digital circuit for clock division 335. Clock division 335 uses a higher frequency clock, e.g., the local clock 260, to mimic or approximate a lower frequency clock. For example, assume clock one has a frequency of 10 Hz and clock two has a frequency of 2 Hz. For every second that passes, the signal from clock one completes 10 cycles while clock two completes 2 cycles. In other words, if 5 cycles of clock one are counted, then one cycle of clock two has occurred.

In general, the two clock frequencies will rarely, if ever, divide simply into a whole number. Because the clock signal has a particular waveform, a choice may be made about where to demarcate between cycles. These points of demarcation are referred to as clock edges in the present disclosure. For example, if the clock signal is in the form of a square wave, the clock edge may be identified with the point in time where the clock signal transitions from high to low amplitude. After making this choice the task of clock division is accomplished by selecting the clock edge of the higher frequency/rate clock nearest to the clock edge of the lower frequency/rate clock. The error resulting from mismatch between the clock edges of clocks one and two is referred to as the jitter error. Generally, the jitter error decreases as the frequency of high frequency clock increases. However, higher frequency clocks generally use more power.

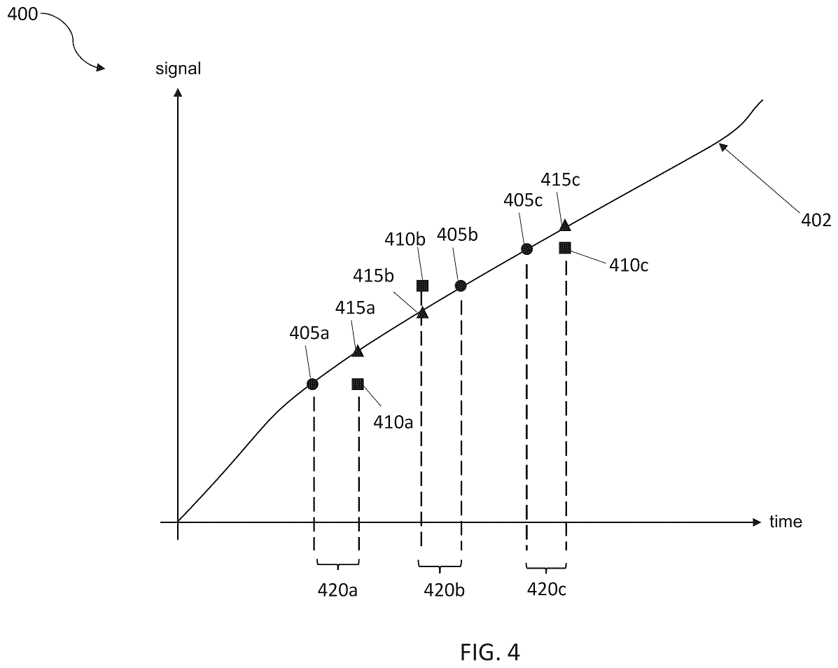

With the sampling rate created by clock division 335, the interpolation block 230 may correct for the jitter error as described herein. In some aspects, the circuitry for clock division 335 may also compute jitter error and provide that to the interpolation block 320. In some examples, interpolation block 320 may use linear interpolation to correct the digital audio samples; however, the interpolation scheme used in the interpolation block 320 is not limited to linear interpolation. Further description of the capability of interpolation block 320 can be found with respect to FIG. 4.

Having corrected the jitter error at the interpolation block 320, the digital audio data may be sent to a CODEC 325. The CODEC 325 may be implemented in software and/or hardware. CODEC 325 converts the digital audio into analog audio which may be provided to a speaker 330.

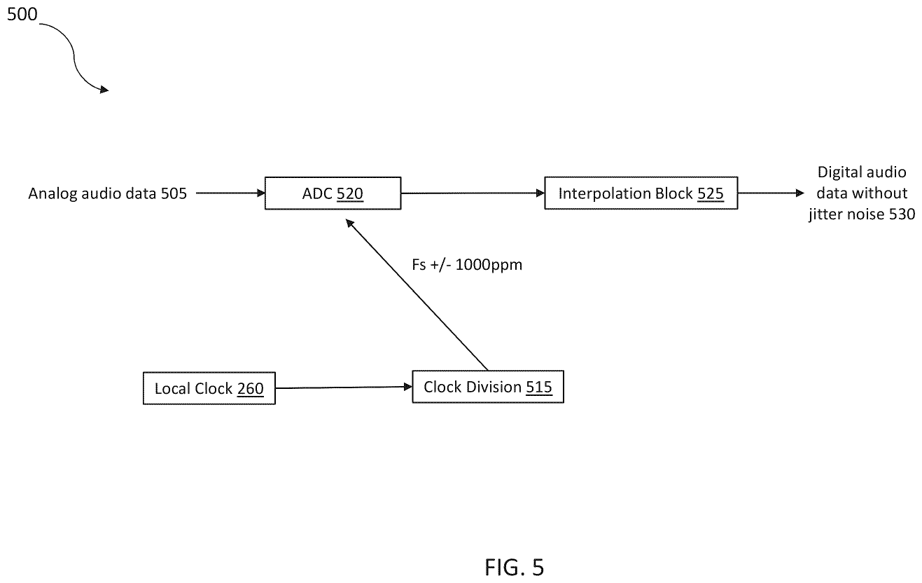

FIG. 4 is a graph 400 of the ideal analogue signal 402 with three sequential points in a digital signal. There are three different types of points depicted in FIG. 4: points for ideal digital samples 405a-c, points for the digital samples that include jitter error 410a-c, and points with correction for jitter error 415a-c. Time increases to the right along the x-axis and the signal amplitude increase up along the y-axis. The ideal analogue signal 402 is the signal after filtering by a CODEC (e.g., 325 in FIG. 3) with an ideal filter. The digital audio samples 405a-c depict the ideal sampling times for the received samples, i.e., if there were no jitter error caused by clock edge differences between the clocks as described herein. Because of the finite timing accuracy of the high-speed clock (e.g., 260 in FIGS. 3 and 5), approximately one-half of the inverse of the frequency of the high-speed clock, digital samples are provided to the CODEC either too early or too late resulting in the digital samples 410a-c with jitter error that deviate from the ideal analogue signal 402. The timing jitter results in the SNR degradation, particularly for signals with high-frequency content. To minimize this degradation, the interpolation block (e.g., 320 and 525 in FIGS. 3 and 5, respectively) estimates the desired sample 415a-c as a linear combination of the samples 405a-c. The samples 405a-c may be used to interpolate samples 415a-c because the jitter errors 420a-c are known and/or calculable. Other schemes for interpolation besides linear interpolation may be used. Because the timing jitter error is small for a high-speed clock, the interpolating filter in the interpolation block may be made very simple and still yield high-fidelity results. For example, even a simple linear interpolation scheme which estimates the corrected samples 415a-c by drawing a line between the nearest two estimated ideal samples 405 a-c may provide very good SNR performance allowing for high-fidelity performance at significantly lower cost compared with traditional resampling techniques.

FIG. 5 a block diagram depicting clock rate-matching 500 for audio conversion, according to some aspects of the present disclosure. An analog audio data stream 505, e.g., from a microphone on, or connected to, a device with a local clock 260, is passed through an analog-to-digital converter (ADC) 520, producing a digital audio sample with jitter error. The digital audio sample is passed through the interpolation block 525 to remove the jitter error. The digital audio data without jitter noise 530 may be transmitted wirelessly to another device.

The description accompanying FIG. 3 focused on audio playback where a remote device wirelessly transmits audio data at a slightly different clock-rate to the local device, and the local device generates the remote audio clock and removes the jitter error to send samples to a CODEC/speaker system. However, the same approach can be used during audio capture where, for example, a microphone records an audio signal which is digitized by an ADC at an arbitrary clock rate approximating the clock rate of a remote system. The latter approach is what is depicted in FIG. 5. As described with respect to FIG. 5 the arbitrary clock rate may be generated using a local lock 260 and a clock division circuit or software module 515. As described with respect to, and as depicted in, FIGS. 3-4, the interpolation block 525 filters the digital audio samples to align them with the ideal analog audio signal.

An available high-speed clock approximates the desired clock rate to resample the signal, and then an interpolation block 525 is used to fix the known jitter error by approximating the value of the analogue signal at the ideal sample times based on a linear combination of the available samples, as described with respect to, and as depicted in, FIG. 4.

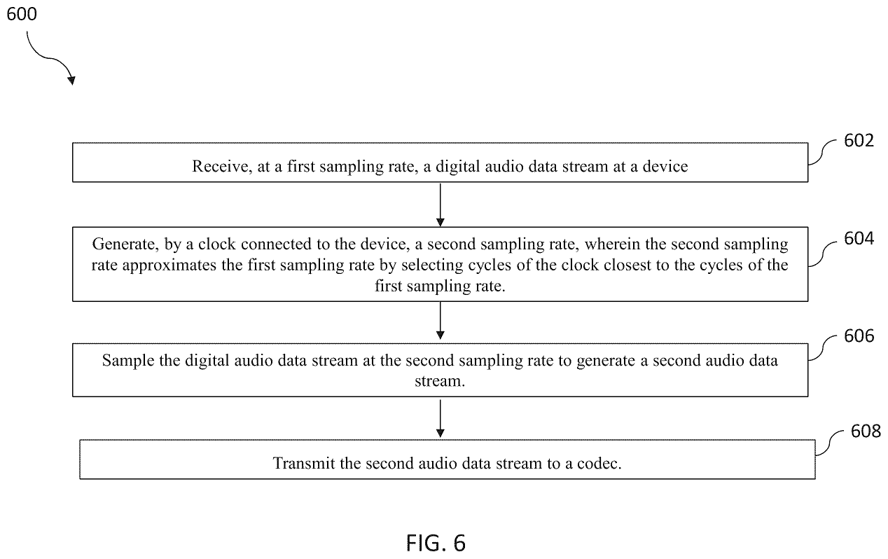

FIG. 6 depicts a method for digital audio conversion, according to some aspects of the present disclosure. Method 600 is merely an example, and is not intended to limit the present disclosure beyond what is explicitly recited in the claims. Additional operations can be provided before, during, and after the method 600, and some operations described can be replaced, eliminated, or moved around for additional embodiments of FIGS. 1-5. For ease of illustration, FIG. 6 is described in connection with FIGS. 1-5.

At step 602, a digital audio data stream (e.g., 305 in FIG. 3) is received (e.g., as input signal 240a at the antenna 215 in FIG. 2) at a device (e.g., 200 in FIG. 2) at a first sampling rate. The first sampling rate may be the clock frequency of a remote device which transmitted the digital audio data stream. The first sampling rate as observed at the receiving device may include error due to the means of wireless transmission, e.g., Bluetooth or Wi-Fi. The use of wireless communication of data may add a sampling frequency error to the sampling rate from a remote device on the order of 1000 ppm. In some embodiments, this sampling frequency error will be estimated based on characteristics of the wireless connection and will be included in the target sampling rate generated by the clock using clock division.

At step 604, generate (e.g., by clock division 335 in FIG. 3) a second sampling rate (e.g., the rate generated by selecting clock edges of the clock 260 using clock division 335 as described with respect to FIG. 3) by a clock (e.g., 260 in FIG. 2-3) connected to the device (e.g., 200 in FIG. 2), wherein the second sampling rate approximates the first sampling rate by selecting cycles of the clock closest to the cycles of the first sampling rate (e.g., as described with respect to FIG. 3). In some embodiments the clock 260 may be integrally formed in the audio device 200 and the use of the term “connected” includes this configuration. In some embodiments, the clock frequency may be between 16 MHz-200 MHz. However, any clock with a frequency greater than the first sampling rate may be used.

At step 606, sample (e.g., at the interpolation block 320 in FIG. 3) the digital audio data stream (e.g., 305 in FIG. 3) at the second sampling rate (e.g., the rate generated by selecting clock edges of the clock 260 using clock division 335 as described with respect to FIG. 3) to generate a second audio data stream. In some embodiments a jitter error generated by clock division will be corrected by an interpolation block 320 as depicted in, and described with respect to, FIG. 3.

At step 608, transmit (e.g., by or within the processor 210 in FIG. 2) the second audio data stream to a codec (e.g., 325 in FIG. 3, 232 in FIG. 2).

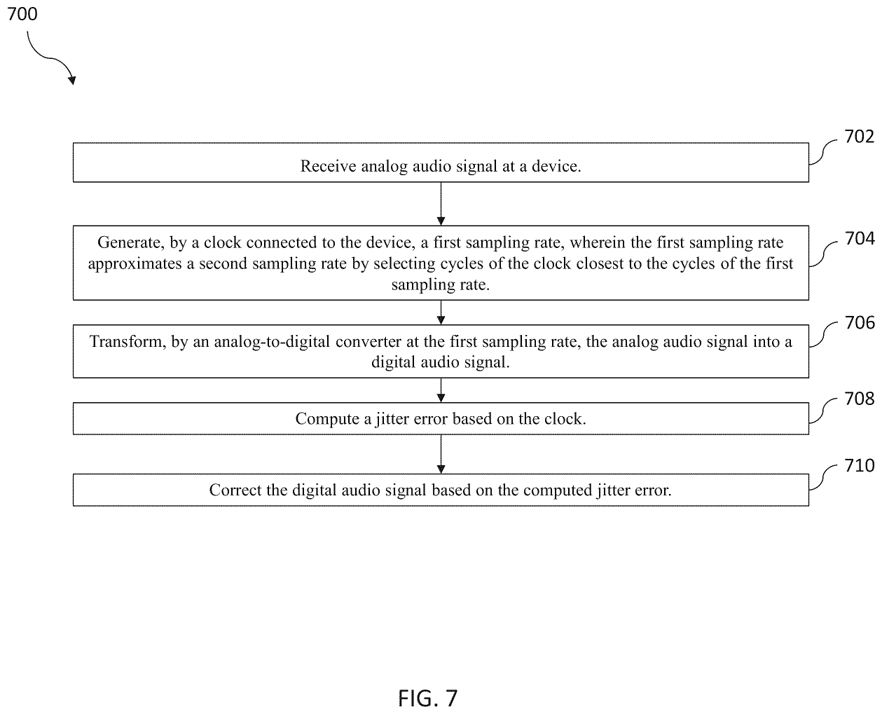

FIG. 7 depicts a method for digital audio conversion, according to some aspects of the present disclosure. Method 700 is merely an example, and is not intended to limit the present disclosure beyond what is explicitly recited in the claims. Additional operations can be provided before, during, and after the method 700, and some operations described can be replaced, eliminated, or moved around for additional embodiments of FIGS. 1-5. For case of illustration, FIG. 6 is described in connection with FIGS. 1-5.

At step 702, receive (e.g., through the microphone 270 in FIG. 2) analog audio signal (e.g., 505 in FIG. 5) at a device (e.g., 200 in FIG. 2).

At step 704, generate (e.g., by clock division 515 in FIG. 5) a first sampling rate by a clock (e.g., 260 in FIG. 5) connected to the device (e.g., 200 in FIG. 2), wherein the first sampling rate approximates a second sampling rate by selecting cycles of the clock closest to the cycles of the first sampling rate (e.g., as described with respect to FIGS. 3 and 5). In some embodiments the clock 260 may be integrally formed in the audio device 200, and the use of the term “connected” includes this configuration. In some embodiments, the clock frequency may be between 16 MHz-200 MHz. However, any clock with a frequency greater than the first sampling rate may be used.

At step 706, transform, by an analog-to-digital converter (e.g., 520 in FIG. 5) at the first sampling rate (e.g., the rate generated by selecting clock edges of the clock 260 using clock division 515 as described with respect to FIGS. 3 and 5), the analog audio signal (e.g., 505 in FIG. 5) into a digital audio signal.

At step 708, compute (e.g., at 515 in FIG. 5) a jitter error (e.g., as described with respect to FIGS. 3-5) based on the clock (e.g., 260 in FIG. 5). In some embodiments, the jitter error may be computed in software, i.e., instructions stored in memory 220, or hardware, e.g., in digital circuitry for clock division 515.

At step 710, correct (e.g., using interpolation block 525 in FIG. 5) the digital audio signal (e.g., the signal as processed by the ADC 520) based on the computed jitter error (e.g., in software, e.g., instructions stored in memory 220, or hardware, e.g., in digital circuitry for clock division 515). In some embodiments, the correct digital audio signal 530 is transmitted to another device wirelessly over Bluetooth, Wi-Fi, or other wireless protocol. The use of wireless communication of data may add a sampling frequency error to the sampling rate from a remote device on the order of 1000 ppm. In some embodiments, this sampling frequency error will be estimated based on characteristics of the wireless connection and included in the target frequency generated by the clock using clock division.

Those skilled in the art will recognize improvements and modifications to the preferred embodiments of the present disclosure. All such improvements and modifications are considered within the scope of the concepts disclosed herein and the claims that follow.

What is claimed is:

1. A method for digital audio conversion comprising:
receiving, at a first sampling rate, a digital audio data stream at a device;
generating, by a clock connected to the device, a second sampling rate,
wherein the second sampling rate approximates the first sampling rate by selecting cycles of the clock closest to the cycles of the first sampling rate;
sampling the digital audio data stream at the second sampling rate to generate a second audio data stream; and
transmitting the second audio data stream to a codec.

2. The method of claim 1, wherein the clock has a frequency between 16 MHz and 200 MHz.

3. The method of claim 1, wherein the digital audio data stream is received over Bluetooth.

4. The method of claim 1, wherein the digital audio data stream is received over Wi-Fi.

5. The method of claim 1, wherein the first sampling rate includes a sampling frequency error.

6. The method of claim 5, further comprising estimating, at the device, the sampling frequency error.

7. The method of claim 1, wherein the generating a second sampling rate further comprises correcting for a jitter error.

8. The method of claim 7, wherein the jitter error is corrected using interpolation.

9. A method for digital audio conversion comprising:
receiving analog audio signal at a device;
generating, by a clock connected to the device, a first sampling rate,
wherein the first sampling rate approximates a second sampling rate by selecting cycles of the clock closest to the cycles of the first sampling rate;
transforming, by an analog-to-digital converter at the first sampling rate, the analog audio signal into a digital audio signal;
computing a jitter error based on the clock; and
correcting the digital audio signal based on the computed jitter error.

10. The method of claim 9, wherein the clock has a frequency between 16 MHz and 200 MHz.

11. The method of claim 9, further comprising transmitting the corrected digital audio signal over Bluetooth.

12. The method of claim 9, further comprising transmitting the corrected digital audio signal over Wi-Fi.

13. The method of claim 9, wherein the first sampling rate includes a sampling frequency error.

14. The method of claim 9, wherein the digital audio signal is corrected using interpolation.

15. A device, comprising:
a transmitter;
a receiver;
a clock;
a non-transitory memory storing instructions; and
one or more hardware processors configured to execute the instructions to cause the device to perform operations comprising:
receiving, at a first sampling rate, a digital audio data stream at a device;
generating, by a clock connected to the device, a second sampling rate,
wherein the second sampling rate approximates the first sampling rate by selecting cycles of the clock closest to the cycles of the first sampling rate;
sampling the audio data stream at the second sampling rate to generate a second audio data stream; and
transmitting the second audio data stream to a codec.

16. The device of claim 15, wherein the clock has a frequency between 16 MHz and 200 MHz.

17. The device of claim 15, wherein the digital audio data stream is received over Bluetooth.

18. The device of claim 15, wherein the digital audio data stream is received over Wi-Fi.

19. The device of claim 15, wherein one or more hardware processors are further configured to execute instructions to cause the device to perform operations further comprising:
correcting jitter error in the second audio data stream.

20. The device of claim 19, wherein the jitter error is corrected using interpolation techniques.
